(19) United States
(12) Patent Application Publication
(10) Pub. No.: US 2013/0193668 A1
(43) Pub. Date: Aug. 1, 2013

(54) ADULT TRICYCLE

(71) Applicants: Ronald Decker, Camden, TN (US); Tim Decker, Camden, TN (US)

(72) Inventors: Ronald Decker, Camden, TN (US); Tim Decker, Camden, TN (US)

(21) Appl. No.: 13/746,209

(22) Filed: Jan. 21, 2013

Related U.S. Application Data
(60) Provisional application No. 61/588,973, filed on Jan. 20, 2012.
(60) Provisional application No. 61/597,417, filed on Feb. 10, 2012.

(51) Int. Cl. B62K 5/06; A01K 1/04; B62M 1/36

(52) U.S. Cl. CPC B62K 5/06; B62M 1/36; A01K 1/04
USPC 280/261; 280/282; 119/771

(57) ABSTRACT

A tandem tricycle having a front frame portion and a detachable rear frame portion, which is configured to accommodate two riders. A drivetrain allows the riders to independently power the tricycle. A full suspension assembly provides a smoother ride.

### CROSS-REFERENCE TO RELATED APPLICATIONS

This Non-Provisional application claims priority to U.S. Provisional Application Ser. Nos. 61/588,973 filed Jan. 20, 2012 and 61/597417 filed Feb. 10, 2012, both of which are incorporated herein by reference.

### STATEMENT REGARDING FEDERALLY SPONSORED RESEARCH

Not Applicable.

### BACKGROUND

The invention relates to an adult tricycle, and particularly a rear assembly that can be used with either an adult tandem tricycle or a front portion which is adapted to connect a dog leash to the frame to facilitate allowing a dog to run along next to the tricycle.

When many people hear the term “tricycle”, they think of the three-wheeled vehicle used by small children. However, tricycles are becoming increasingly popular with adults, particularly older adults, for recreational, shopping, and exercise. In some areas of the world, tricycles are used for transport of freight and people. Tricycles have many advantages over bicycles, such as stability, safety, and comfort. However, tricycles are larger and heavier than bicycles, which makes them harder to store. They also take more space on the roads or paths they travel.

Therefore, what is needed is an adult tricycle that can accommodate multiple riders or pets and is easier to store.

### DESCRIPTION OF THE DRAWINGS

In the accompanying drawings which form part of the specification:

FIG. 1 is a perspective view of a tandem tricycle;

FIG. 2 is a partial enlarged perspective view of a linking assembly;

FIG. 3 is a partial enlarged perspective view of a drivetrain assembly;

FIG. 4 is another partial enlarged perspective view of the drivetrain assembly;

FIG. 5 is a perspective view of a rear portion;

FIG. 6 is a perspective view of a first alternate embodiment of a tandem tricycle;

FIG. 7 is a perspective view of a second alternate embodiment of a tricycle with a leased pet;

FIG. 8 is a perspective view of the second alternate embodiment of the tricycle;

FIG. 9 is a partial enlarged perspective view of steering cables;

FIG. 10 is a perspective view of the rear portion;

FIG. 11 is a side view of the front portion and linking assembly;

FIG. 12 is a perspective view of an extension assembly;

FIG. 13 is a partial perspective view of the steering cables; and

FIG. 14 is partial perspective view of the drivetrain.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

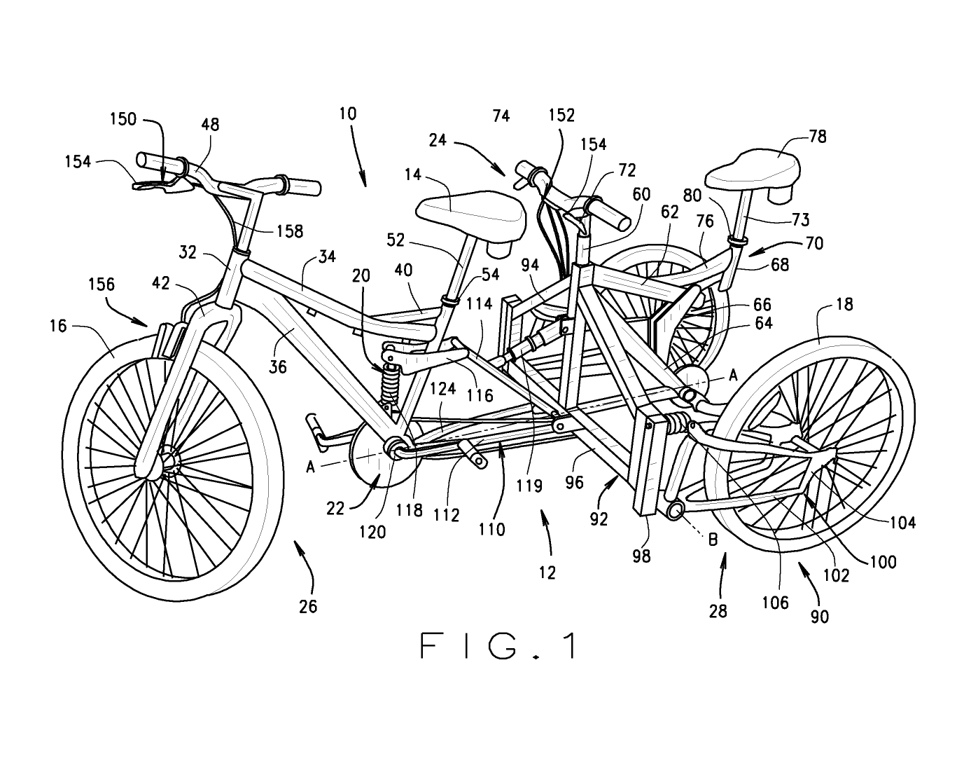

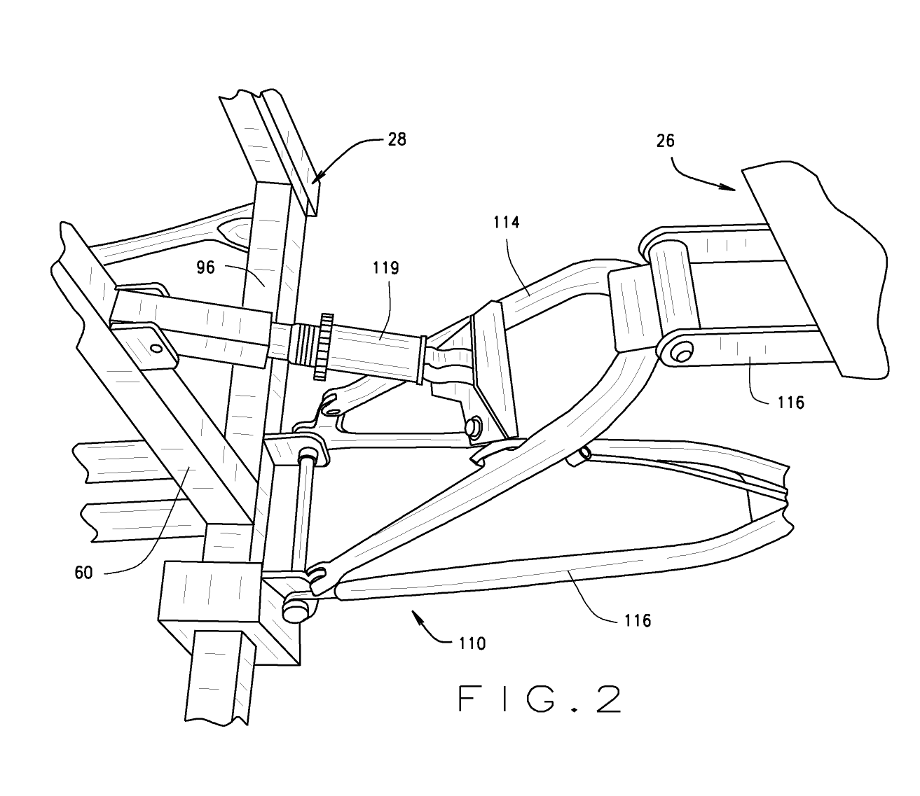

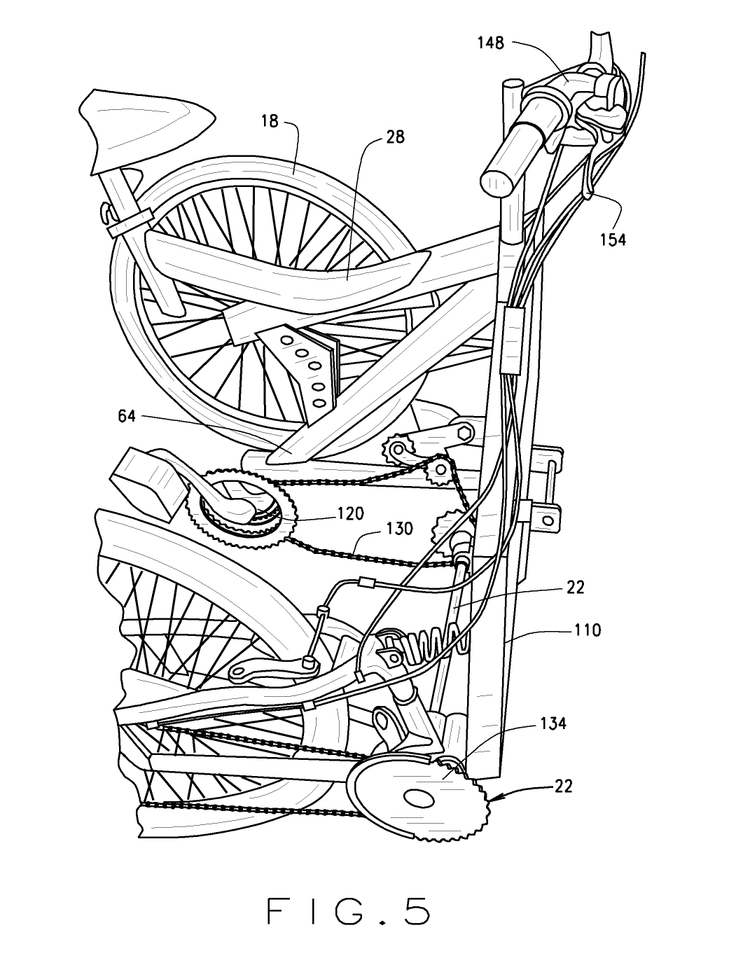

As shown in FIGS. 1-5, an adult tandem tricycle 10, includes a frame 12 configured to support two riders with seats 14. A front wheel 16 and two rear wheels 18 are arranged in a generally triangular or tricycle configuration to support the frame 12 so that the tricycle 10 can stand on its own. A full suspension assembly 20 operatively connects to the frame 12 to provide a smoother ride. A drivetrain 22 mounts to the frame 12 for engagement by the riders and operatively connects to the wheels 16 and 18. A brake assembly 24 mounts to the frame 12 for engagement by the riders and operatively connects to the wheels 16 and 18. To operate the tricycle 10, one or both of the riders engage the drivetrain 22 and brake assembly 24 to power and stop the tricycle 10. For easier transportation and storage, the frame 12 can dissemble into a first portion 26 and rear portion 28, which are connected with a linkage assembly 30 generally along a centerline A-A.

The first or front portion 26 of the frame 12 includes a head tube 32, a top tube 34, a down tube 36, and a seat tube 40 connected in a generally triangular arrangement. The head tube 32 and seat tube 40 are positioned in a generally vertical position with the top tube 34 connected between the upper ends of the head tube 32 and the seat tube 40, and with the down tube 36 connected between the lower ends of the head tube 32 and seat tube 40. The head tube 32 defines a bore configured to receive a pivoting front fork 42, which can include a bearing. Preferably, each arm 44 of the front fork 42 includes suspension devices, such as shock absorbers 46. Handlebars 48 attach to the upper end of the front fork 42 for engagement by the rider to steer the tricycle 10. A saddle or seat 50 attaches to the top of a post 52 which inserts within the seat tube 40. A clamp 54 detachably secures the post 52 and seat 50 at a desired elevation.

The second or rear portion 28 of the frame 12 also includes a head tube 60, a top tube 62, a down tube 64, a seat bracket 66, and a seat tube 68 connected in a generally rectangular arrangement with a cantilever seat 70. The head tube 60 and seat bracket 66 are positioned in a generally vertical position with the top tube 62 connected between the upper ends of the head tube 60 and the seat bracket 66, and with the down tube 64 connected between the lower ends of the head tube 60 and seat bracket 66. The head tube 60 defines a bore configured to receive a handle bar post 72. Handlebars 74 attach to the upper end of the handlebar post 72 for engagement by the rider for support. However, the handlebars 74 in the rear portion 28 are not used to steer the tricycle 10. The seat tube 68 connects to the rear end of the top tube 62 with a cantilever support 76. A seat 78 attaches to the top of a post 73 which inserts within the seat tube 68. A clamp 80 secures the post 72 and seat 78 at a desired elevation.

The frame rear portion 28 also includes a pair of wheel extension assemblies 90 that position the rear wheels 18 on each side of the centerline A-A at a predetermined distance from each other. Each extension assembly 90 includes a generally triangular truss 92 extending outwardly from the head tube 60. The truss 92 includes an upper tube 94 and lower tube 96 connected between the head tube 60 and an end tube 98. Each rear wheel 18 moveably connects to a respective end tube 98 with a wheel cage 100, which generally includes a pair of chain stays 102 connected by uprights 104. A lower portion of the wheel cage 100 pivotally connects to a lower portion of the end tube 98 at pivot point B, while an upper portion of the wheel cage 100 moveably connects to the upper portion of the end tube 98 with a suspension element 106, such as a shock absorber. In this configuration, the wheel cage 100 and wheel 18 can pivot about pivot point B along a distance dictated by the stroke of the suspension element 106.

A linkage assembly 110 detachably connects the front portion 26 with the rear portion 28. The linage assembly 110 includes a chain stay 112 detachably connected between the bottoms of the seat tubes 40 and 68, such as with fasteners. A seat stay 114 pivotally mounts, such as with fasteners, between the bottom of the rear head tube 60 and a link 116, which is pivotally mounted to the front seat tube 40 at a pivot point C. A suspension element 118 pivotally connects between the down tube 36 and a front portion of the link 116, such as with fasteners. The relationship between the chain stay 112, seat stay 114, link 116, and suspension element 118 is sometimes referred to as a four-bar suspension arrangement. The linkage assembly 110 also includes a suspension element 119 detachably connected between about the midpoint of the seat stay 114 and about the midpoint of the rear head tube 60. To detach the front portion 26 from the rear portion 28, the chain stay 112, seat stay 114, and suspension element 118 detach from the rear head tube 60, such as by removing fasteners. In this way, the linkage assembly 110 detachably connects the front portion 26 to the rear portion 28, while providing suspension features to the tricycle 10.

In the embodiment of FIGS. 1-5, the frame 12 includes a generally triangular front portion 26 and a generally rectangular rear portion 28. However, any shape and size of frame can be used, including, but not limited to diamond, step-through, truss, cross, cantilever, Y-foil, recumbent, and the like. In addition, the geometry of the frame components, such as, angles and orientations, can vary according to design factors, such as balance, handling, stability, strength, and steering. The frame 12 can comprise any suitable material, including, but limited to, steel, aluminum, carbon fiber, chromium-molybdenum steel alloys, thermoplastic, titanium, composites and the like.

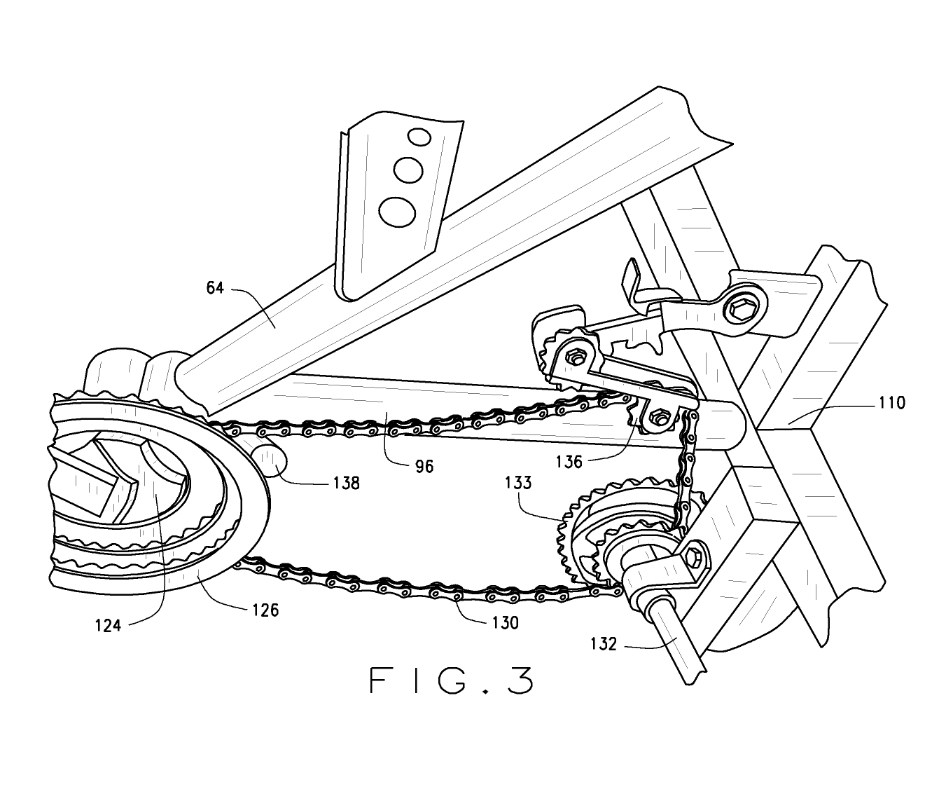

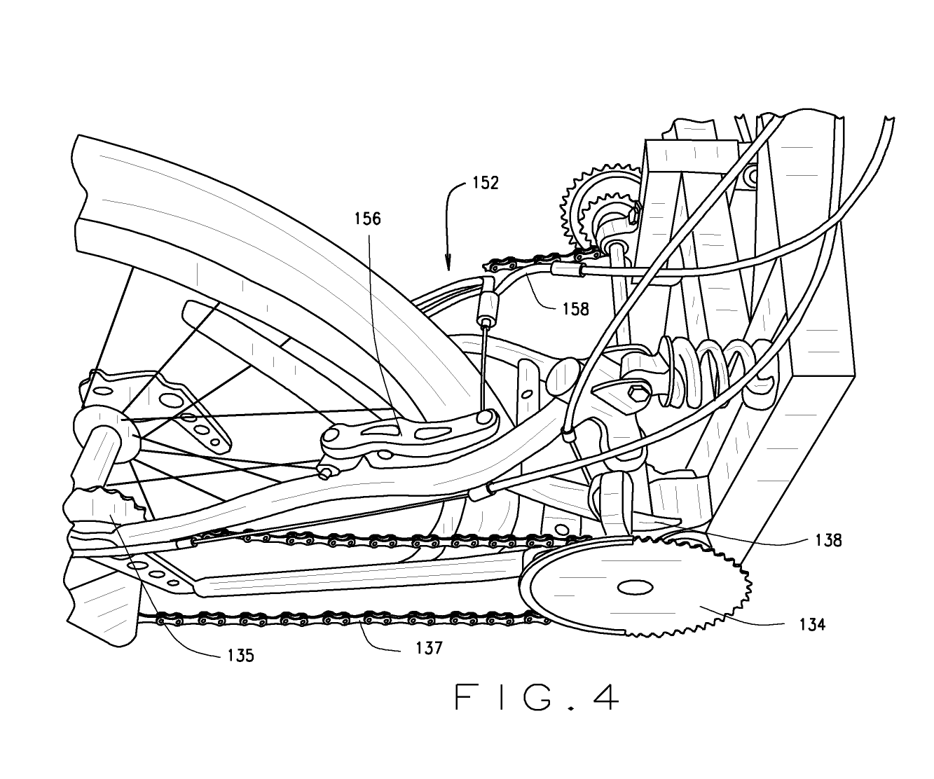

The drivetrain 22 includes a crankshaft 120 with pedals attached to the front end of the chain stay 112 of the front portion 26. A set of gears, or cassette 122, connects to the crankshaft 120 for engagement with a front chain 124 (FIG. 1). The rear portion 28 also includes a crankshaft 124 with pedals attached to rear end of the down tube 64. A set of gears, or cassette 126, connects to the crankshaft 124 for engagement with a rear chain 130 (FIG. 3). A driveshaft 132 rotatably mounts to the lower tube 96 of the wheel extension 110 and includes a pair of sprockets 133 for engagement with respective front chain 124 and rear chain 130. A third sprocket 134 on the driveshaft 132 operatively connects to a rear cassette 135 on one of the rear wheels 18 with wheel chain 137. In this configuration, one or both riders can transfer power through the crankshafts 120 and 124 to the driveshaft 132 and to the rear wheel 18 (FIG. 4). The drivetrain 22 also includes chain tensioners 136, derailleurs 138, and shifters 140 to allow the rider to select different gears.

The suspension assembly 20 includes components that are discussed above, but work together to provide a smooth ride for the tricycle. The components include the shock absorbers 46 on the front fork 42, the four-bar suspension arrangement, and the suspension elements 106 and 118.

The brake assembly 24 includes a front brake subassembly 150 and a rear brake subassembly 152 (FIGS.1 and 4-5). The front brake subassembly 150 includes a brake lever 154 mounted to the handlebars 48 and operatively connected to the brakes 156 on the front wheel 16 with cables 158. The brakes 156 can be any suitable type of brakes, such as, disc, caliper, V-brakes, cantilever, or U-brakes. Similarly, the rear brake subassembly 152 includes a brake lever 154 mounted to the handlebars 74 and operatively connected to the brakes 156 on one or both of the rear wheel 18 with cables 158 The brakes 156 can be any suitable type of brakes, such as, disc, caliper, V-brakes, cantilever, or U-brakes.

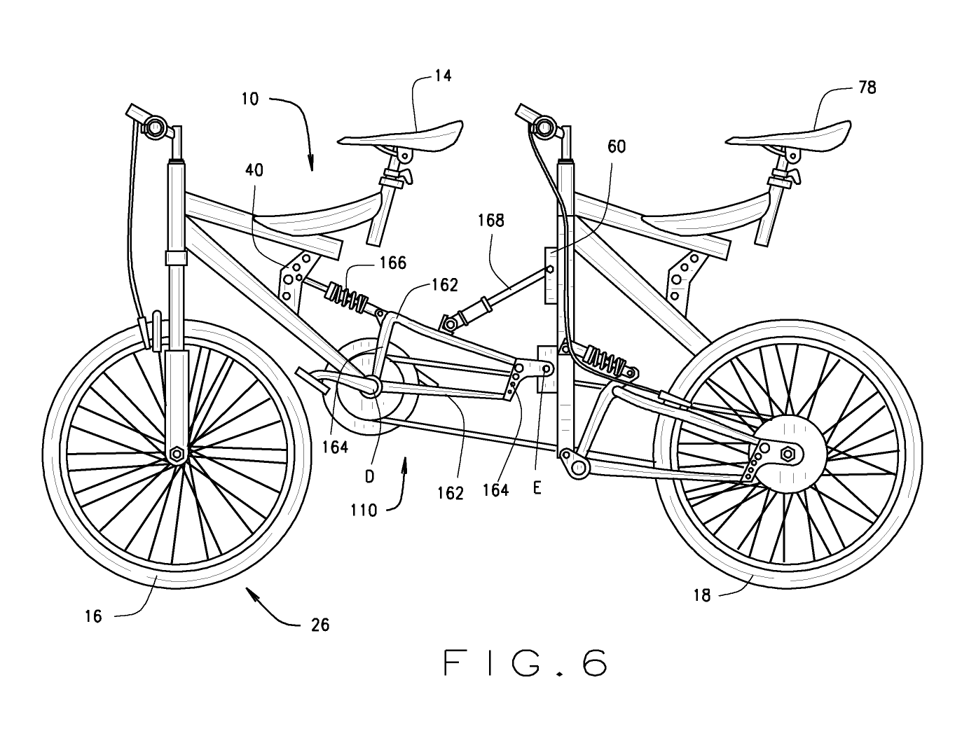

In an alternate embodiment shown as FIG. 6, the linking assembly 110 substitutes the four-bar suspension arrangement with a single point pivot arrangement. One end of a suspension cage 160 pivotally attaches between the front portion at pivot point D and the rear portion of the frame 12 at pivot point E. The suspension cage 160 generally includes a pair of chain stays 162 connected by uprights 164. A front lower portion of the suspension cage 160 pivotally connects to a lower portion of the down tube 36 at pivot point D, while a front upper portion of the wheel cage 100 moveably connects to about the midpoint of the seat tube 40 with a suspension element 166, such as a shock absorber. The rear portion of the suspension cage 160 pivotally connects at pivot point E of the rear portion 28, such as the wheel extensions 110. Another suspension element 168 pivotally connects between the upper chain stay 162 and the rear head tube 60. In this configuration, the suspension cage 160 can pivot about pivot points D and E along a distance dictated by the stroke of the suspension elements 166 and 168. To detach the front portion 26 from the rear portion 28, the suspension cage 160, and suspension element 166 detach from the rear head tube 60, such as by removing fasteners.

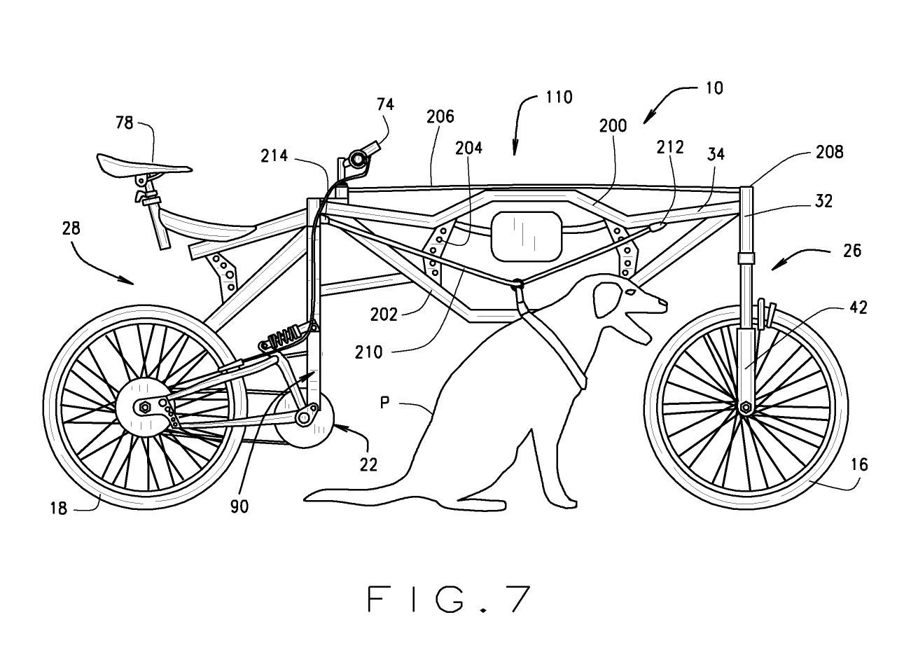

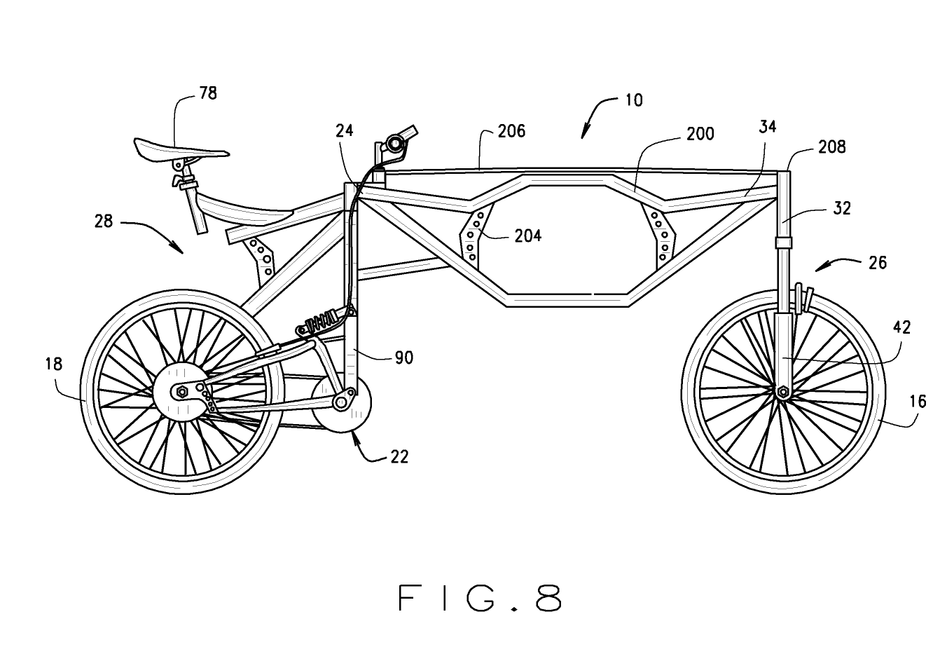

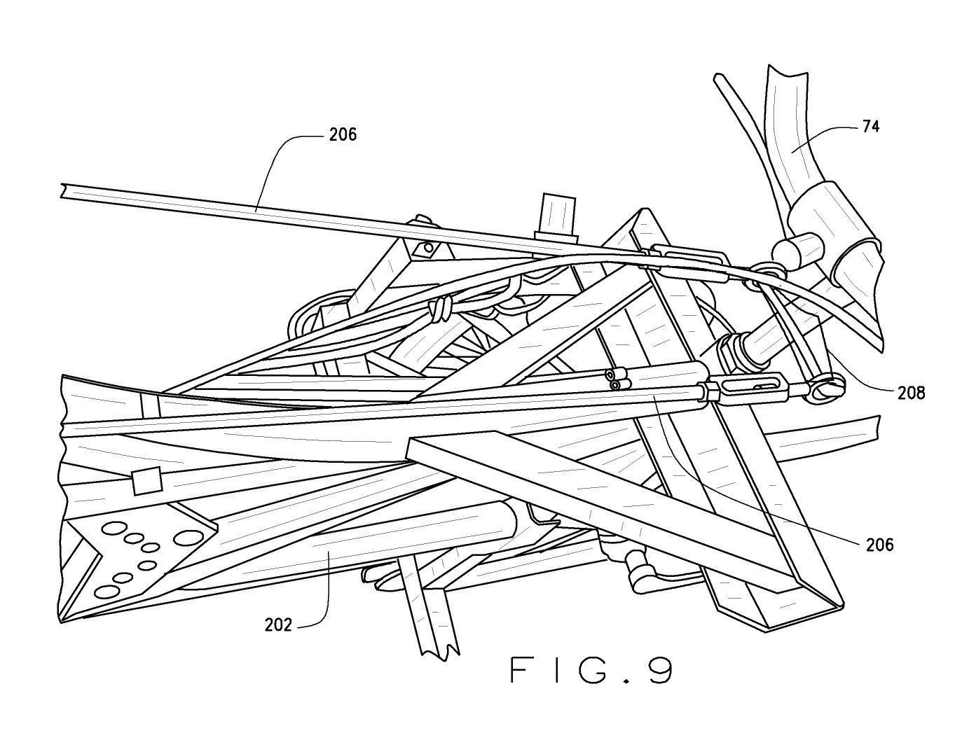

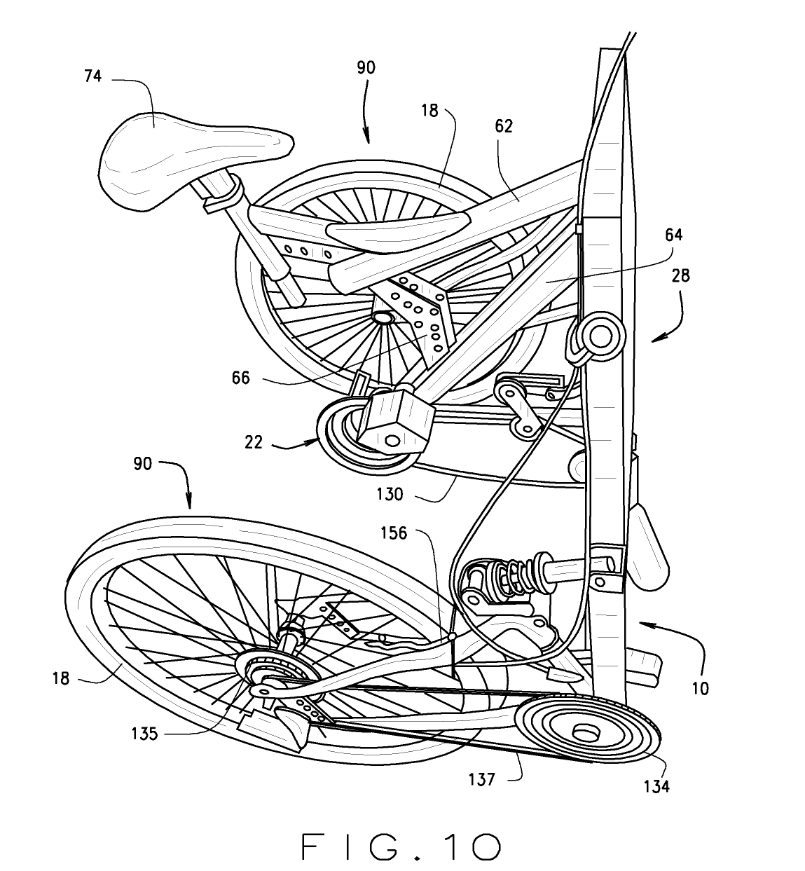

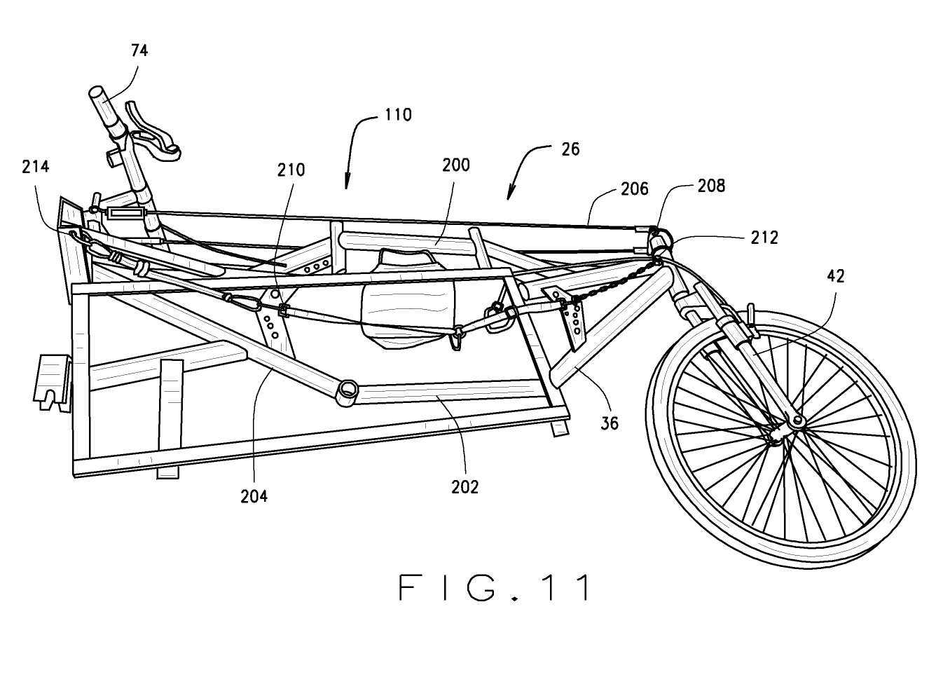

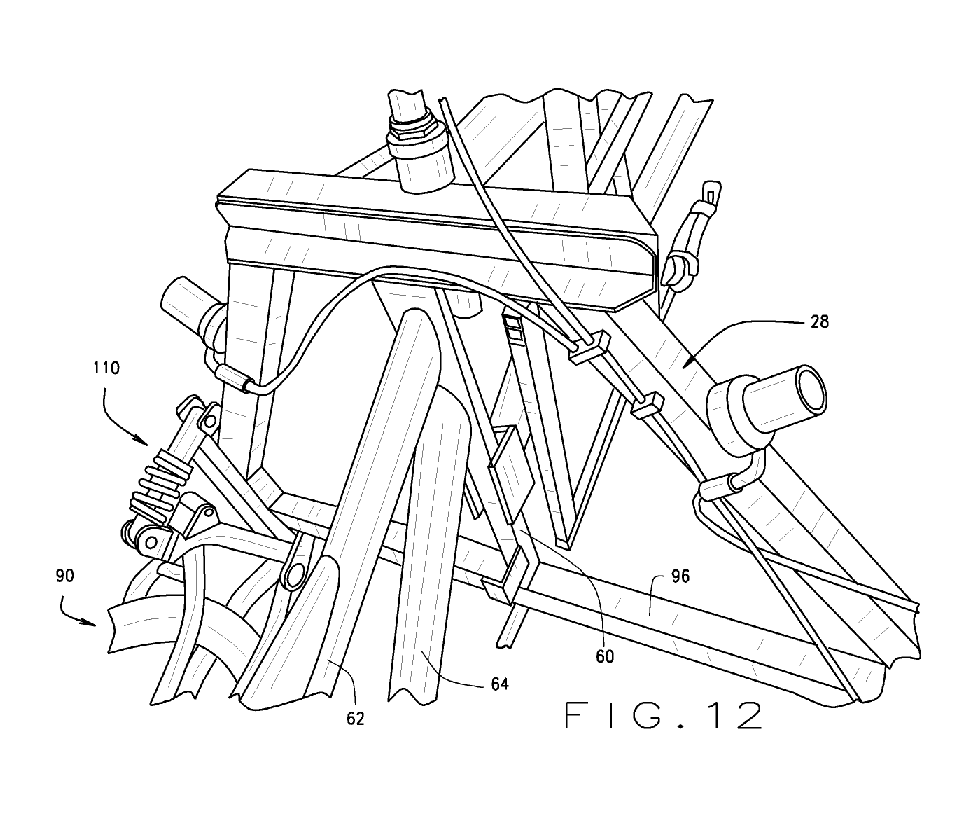

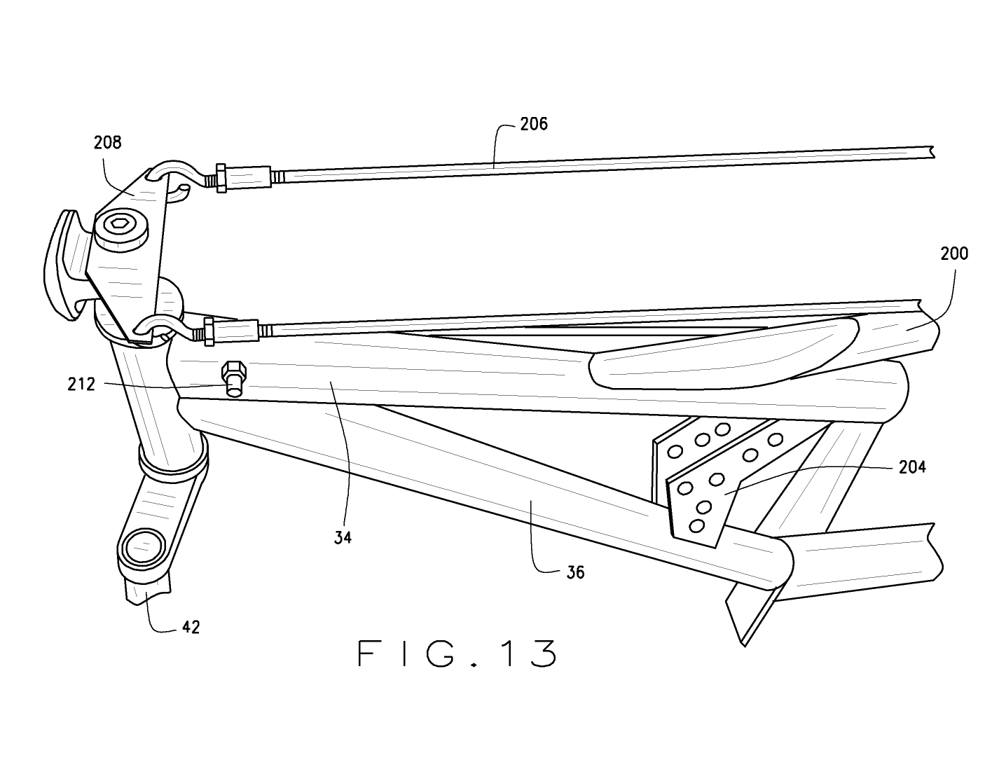

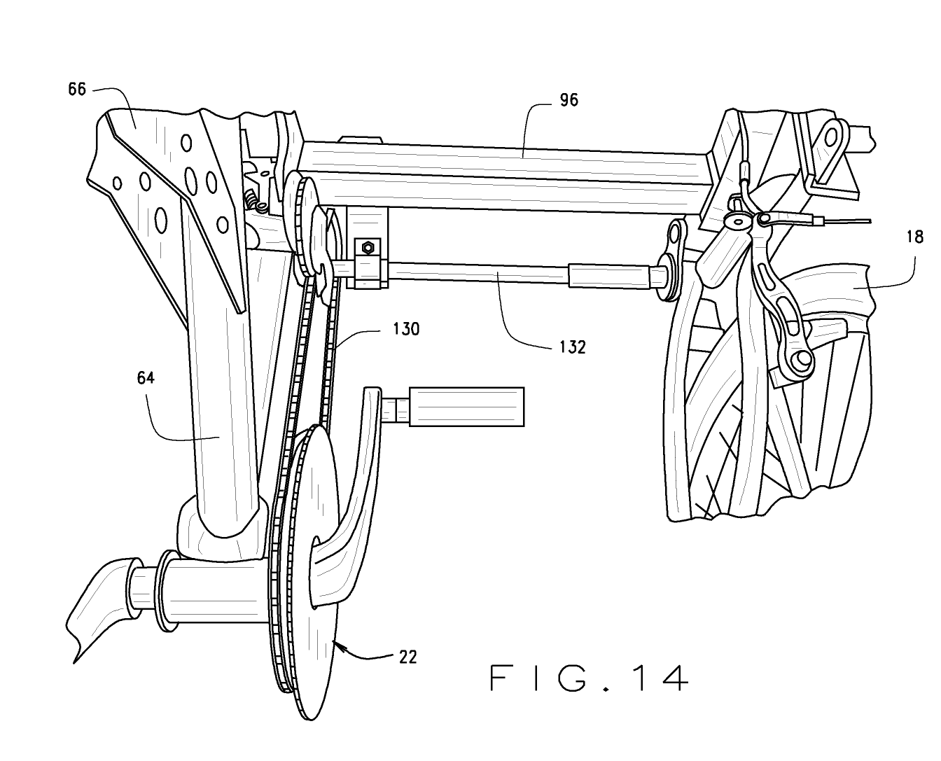

In another alternate embodiment shown in FIGS. 7-14, the tricycle 10 includes an alternate arrangement of the linkage assembly 110 that includes a upper tube 200 attached to the top tube 34, a bottom tube 202 attached to the down tube 36, and a set of rear braces 204 attached between the upper tube 200 and bottom tube 202 that detachably connect to the rear portion 28. A pair of cables 206 connect between the handlebars 74 and a generally triangular connector plate 208 attached at the top of the front head tube 32. As the rider turns the handlebars 74 back and forth, the cable turns the connector plate 208, fork 42, and wheel 16, accordingly. A leash 210 connects between a first connection point 212 at the front of the top tube 34 and a second connection point 214 at the extension assembly 90, so that a pet can accompany the rider during a ride. All or a portion of the leash can comprise a flexible element, such as a bungee cord, that provides some elasticity in the connection between the pet and the tricycle 10. This provides some additional freedom of movement to the pet and reduces the chances of the pet overturning the tricycle 10.

This alternate embodiment only accommodates one rider located in the rear portion. Therefore, none of the components to accommodate a rider in the front portion are needed, such as, handlebars 48, seat 50, and related drivetrain assembly components.

Changes can be made in the above constructions without departing from the scope of the invention, it is intended that all matter contained in the above description or shown in the accompanying drawings shall be interpreted as illustrative and not in a limiting sense.

What is claimed is:

1. A tandem tricycle, comprising:
a front frame portion configured to accommodate a rider;
a front wheel pivotally mounted to the front frame portion;
a rear frame portion detachably connected to the from frame portion, the rear frame portion configured to accommodate a rider;
a pair of rear wheels pivotally connected to the rear frame portion;
a drivetrain operatively connected to at least one of the rear wheels; and
a suspension assembly operatively connected to the front frame portion and the rear frame portion.

2. The tandem tricycle of claim 1, the rear frame portion comprising a wheel extension assembly to position the rear wheels at a predetermined distance from each other.

3. The tandem tricycle of claim 2, the rear frame portion further comprising:
a wheel cage pivotally attached between the wheel extension assembly and one of the rear wheels;
a suspension element pivotally moveably connected between the wheel cage and the wheel extension assembly.

4. The tandem tricycle of claim 1, the drivetrain comprising:
a driveshaft pivotally mounted to the rear portion;
a front crankshaft pivotally attached to the front portion and operatively connected to the driveshaft;
a rear crankshaft pivotally mounted to the rear portion and operatively connected to the driveshaft;
a chain operatively connected between the driveshaft and at least one of the rear wheels.

5. The tandem tricycle of claim 1, the front frame portion comprising:
a linkage assembly detachably connecting the front frame portion to the rear frame portion.

6. The tandem tricycle of claim 5, the linkage assembly comprising:
a four-bar arrangement pivotally connected between the front frame portion and the rear frame portion; and
a suspension element moveably connected between the four-bar arrangement and the rear frame portion.

7. The tandem tricycle of claim 1, further comprising a brake assembly operatively connected to the front wheel or the rear wheels.

8. A tandem tricycle, comprising:
a front frame configured to accommodate a rider;
a front wheel pivotally mounted to the front frame portion;
a rear frame configured to accommodate a rider;
a pair of rear wheels pivotally connected to the rear frame portion;
a linkage assembly detachably connecting the front frame to the rear frame;
a drivetrain operatively connected to at least one of the rear wheels; and
a suspension assembly operatively connected to the front frame portion and the rear frame portion.

9. The tandem tricycle of claim 8, the linkage assembly comprising:
a four-bar arrangement pivotally connected between the front frame and the rear frame; and
a suspension element moveably connected between the four-bar arrangement and the rear frame.

10. The tandem tricycle of claim 8, the rear frame portion comprising a wheel extension assembly to position the rear wheels at a predetermined distance from each other.

11. The tandem tricycle of claim 10, the rear frame portion further comprising:
a wheel cage pivotally attached between the wheel extension assembly and one of the rear wheels; and
a suspension element pivotally moveably connected between the wheel cage and the wheel extension assembly.

12. The tandem tricycle of claim 8, further comprising a brake assembly operatively connected to the front wheel or the rear wheels.

13. The tandem tricycle of claim 1, the drivetrain comprising:
a driveshaft pivotally mounted to the rear portion;
a front crankshaft pivotally attached to the front portion and operatively connected to the driveshaft;
a rear crankshaft pivotally mounted to the rear portion and operatively connected to the driveshaft; and
a chain operatively connected between the driveshaft and at least one of the rear wheels.

14. A tricycle, comprising:
a front frame portion having a first connection point;
a front wheel pivotally mounted to the front frame portion;
a rear frame portion detachably connected to the from frame portion, the rear frame portion configured to accommodate a rider, and having a second connection point;
a pair of rear wheels pivotally connected to the rear frame portion;
a pet leash detachably connected between the first connection point and the second connection point;
a drivetrain operatively connected to at least one of the rear wheels; and
a suspension assembly operatively connected to the front frame portion and the rear frame portion.
